(19) United States
(12) Patent Application Publication
(10) Pub. No.: US 2026/0085164 A1
(43) Pub. Date: Mar. 26, 2026

(54) HIGH MECHANICAL STRENGTH POLYMER THIN FILM, MANUFACTURING METHOD THEREFOR, AND USE THEREOF

(71) Applicant: Yangzhou Nanopore Innovative Materials Technology Ltd., Jiangsu (CN)

(72) Inventors: Zhongya Zhu, Jiangsu (CN); Shuai Wang, Jiangsu (CN); Jianzhong Xia, Jiangsu (CN); Xuefa Li, Jiangsu (CN); Guoping Zhang, Jiangsu (CN)

(73) Assignee: Yangzhou Nanopore Innovative Materials Technology Ltd., Jiangsu (CN)

(21) Appl. No.: 19/112,681

(22) PCT Filed: Sep. 20, 2022
(86) PCT No.: PCT/CN2022/119870

§ 371 Date: Mar. 18, 2025

(51) Int. Cl. C08J 5/18; B32B 15/04; B32B 15/08; B32B 15/20; B32B 27/36; B32B 38/00; C08J 7/04; C09D 7/61; C09D 7/63; H01M 4/1399; H01M 10/0525

(52) U.S. Cl. CPC C08J 5/18; B32B 15/043; B32B 15/08; B32B 15/20; B32B 27/36; B32B 38/0036; B32B 38/164; C08J 7/04; C09D 7/61; C09D 7/63; H01M 4/1399; H01M 10/0525; B32B 2038/0028; B32B 2038/0068; B32B 2307/21; B32B 2307/746; B32B 2309/02; B32B 2309/105; B32B 2311/02; B32B 2311/18; B32B 2311/22; B32B 2313/04

(57) ABSTRACT

The present application relates to a high mechanical strength polymer thin film. The high mechanical strength polymer thin film comprises, by mass percentage, 95%-99% of polyester and 1%-5% of an auxiliary agent. The number average molecular weight of the polyester is 13000 Da to 20000 Da. The molecular number of the polyester with the molecular weight smaller than 5000 Da accounts for 0.5%-5% of the total molecular number of the polyester. A molecular weight distribution index of the polyester is 1.6-2.4.

### TECHNICAL FIELD

The present application relates to the technical field of polymer film preparation, and in particular relates to a high mechanical strength polymer film, a preparation method therefor, and use thereof.

### BACKGROUND

A composite current collector can be prepared by using the physical vapor deposition (PVD) method to deposit metal materials on a polymer film, and the polymer film may adopt a polypropylene film, a polyethylene film or a polyester film, etc. Compared with traditional current collectors, composite current collectors are light in weight, cheap in cost, and have good internal insulation, so the energy density and safety of the battery can be greatly improved when the composite current collectors is applied to the battery, especially in consumer batteries or power batteries such as mobile phones, laptops, unmanned aerial vehicles, and electric vehicles.

The polymer base film commonly used for composite current collectors is polyester film, and the traditional polyester film is mostly polyester film for packaging, and when the polyester film for packaging is used in composite current collectors, there exists the problem of poor mechanical properties, especially poor mechanical properties of longitudinal MD, which is mainly manifested in the relatively low elastic modulus and tensile strength in the MD direction (the elastic modulus is generally less than 5000 MPa, and the tensile strength is generally less than 250 MPa). When the polyester film is deposited with metal materials in the PVD system environment, the polyester film is prone to breakage due to the high tension of the winding system in the PVD system environment, the bombardment of metal atoms and the increased temperature of the surface of the polyester film. In addition, the processes of coating and composite molding of products involved in the battery also put forward high requirements for the base film of the composite current collector.

### SUMMARY

According to the Examples in the present application, a high mechanical strength polymer film, a preparation method therefor, and use thereof are provided.

The solution of the present application is as follows:

In a first aspect, a high mechanical strength polymer film is provided in the present application. The polymer film includes a polyester with a mass percentage of 95%-99% and an auxiliary agent of 1%-5%, the number average molecular mass of the polyester is 13000-20000 Da, and the molecular number of the polyester with a molecular weight of less than 5000 Da accounts for 0.5%-5% of the total molecular number of the polyester, and the polydispersity index of the polyester is 1.6-2.4.

In some of the Examples, a preparation method of the polymer film includes the following steps: performing a first longitudinal stretch treatment, a transverse stretch treatment, and a second longitudinal stretch treatment sequentially;
optionally, the process conditions of the first longitudinal stretch include: a first longitudinal stretch ratio of (3.0-4.0):1 and a first longitudinal stretch temperature of 80-120° C.;
optionally, the process conditions of the transverse stretch include: a transverse stretch ratio of (3.0-4.0):1 and a transverse stretch temperature of 90-140° C.;
optionally, the process conditions of the second longitudinal stretch include: a second longitudinal stretch ratio of (1.1-1.3):1 and a second longitudinal stretch temperature of 80-120° C.

In some of the Examples, the polyester includes one or more of polyethylene terephthalate, poly(ethylene 2,6-naphthalate), polybutylene terephthalate, poly(1,4-cyclohexylenedimethylene terephthalate), poly(ethylene glycol-co-1,4-cyclohexanedimethanol terephthalate), poly(trimethylene 2,6-naphthalate), polytrimethylene terephthalate, poly(butylene 2,6-naphthalate), poly(butylene 2,5-furandicarboxylate), poly(butylene adipate-co-terephthalate), and their derivatives.

In some of the Examples, the auxiliary agent includes one or more of a slip agent, an antioxidant, an antistatic agent and a nucleating agent;
optionally, the slip agent includes one or more of calcium carbonate, talcum powder, diatomaceous earth, acrylic ester, siloxane, titanium dioxide, kaolin and silica;
optionally, the antioxidant includes one or more of phosphonate and bisphenol A phosphite;
optionally, the antistatic agent includes one or more of conductive fibers, polyethylene glycol, glycerol, polyether ester, polyglycerol, graphite, and carbon black;
optionally, the nucleating agent includes one or more of sodium carbonate, benzophenone, zinc oxide, copper oxide, magnesium stearate, triphenyl phosphate, aluminum oxide, magnesium oxide, barium sulfate, polycaprolactone, and sodium benzoate.

In a second aspect, a preparation method of the high mechanical strength polymer film as described above is provided in the present application, which includes the following steps:
preparing polyester sheets with 95%-99% of the polyester and 1%-5% of the auxiliary agent;
subjecting the polyester sheets to a crystallization treatment, a drying treatment, a melt-extrusion treatment, a sheet-casting treatment, a first longitudinal stretch treatment, a transverse stretch treatment, and a second longitudinal stretch treatment sequentially to prepare the polymer film.

In some of the Examples, the process conditions of the crystallization treatment include: performing crystallization at a temperature of 135-185° C. for a period of 20-120 min.

In some of the Examples, the process conditions of the drying treatment include: performing drying at a temperature of 135-175° C. for a period of 120-300 min.

In some of the Examples, the melt-extrusion treatment is performed at a temperature of 270-290° C.

In some of the Examples, the sheet-casting treatment includes the following steps: subjecting a material from the melt-extrusion treatment to casting treatment, and then cooling treatment.

In a third aspect, a composite film is provided by the present application. The composite film includes a supporting film and a metal-enrichment layer, and at least one surface of the supporting film is attached with the metal-enrichment layer, and the supporting film includes the polymer film as described above or a polymer film prepared by the preparation method as described above.

In some of the Examples, a material of the metal-enrichment layer includes one or more of titanium, silver, copper, aluminum, nickel, a copper alloy, an aluminum alloy, and a nickel alloy.

In some of the Examples, the metal-enrichment layer has a thickness of 500-2000 nm.

In some of the Examples, the supporting film has a thickness of 1-20 μm.

In a fourth aspect, a composite current collector is provided in the present application, and the composite current collector includes the composite film as described above.

In some of the Examples, a surface of the metal-enrichment layer is attached with a protective layer;
optionally, the protective layer has a thickness of 10-150 nm;
optionally, a material of the protective layer includes one or more of graphite, nickel, chromium, carbon black, copper oxide, acetylene black, aluminum oxide, nickel oxide, Ketjen black, chromium oxide, cobalt oxide, a nickel-based alloy, a copper-based alloy, carbon nano-quantum dots, carbon nanotubes, carbon nanofibers, and graphene.

In a fifth aspect, an electrode sheet is provided in the present application. The electrode sheet includes the composite current collector and an active substance layer attached to at least one surface of the composite current collector.

In a sixth aspect, a lithium secondary battery is provided in the present application, and the lithium secondary battery includes the electrode sheet as described above.

In a seventh aspect, an electronic device is provided in the present application, and the electronic device includes the battery as described above.

Details of one or more Examples of the present application are presented in the description below. The other features, purposes and advantages of the present application will become apparent from the description and the claims.

### DETAILED DESCRIPTION

The technical solutions of the present application are further described below in terms of specific embodiments. Obviously, the described embodiments are only some embodiments of the present application instead of all embodiments. Based on the embodiments in the present application, all other embodiments obtained by the skilled in the art without creative work shall all fall within the protection scope of the present application.

Unless otherwise defined, all technical and scientific terms used herein have the same meanings as generally understood by those skilled in the technical art of the present application. The terms used herein in the description of the present application are for the purpose of describing specific embodiments only and are not intended to limit the present application. The term “one or more” as used herein includes any and all combinations of one or more related listed items.

One embodiment of the present application provides a high mechanical strength polymer film. The polymer film includes a polyester with a mass percentage of 95%-99% and an auxiliary agent of 1%-5%, the number average molecular mass of the polyester is 13000-20000 Da, and the molecular number of the polyester with a molecular weight of less than 5000 Da accounts for 0.5%-5% of the total molecular number of the polyester, and the polydispersity index of the polyester is 1.6-2.4.

It should be noted that the polydispersity index in the present application refers to the ratio of the weight average molecular mass to the number average molecular mass. If the number average molecular mass of the polyester in the aforementioned polymer film is too low, the mechanical properties of the prepared polymer film will be poor; if the number average molecular mass of the polyester is too high, the film-forming property of the polyester will be poor, which leads to the increase of film breakage rate of the polymer film during the preparation process of the film and the decrease of yield rate. The molecular number of the polyester with a molecular weight less than 5000 Da accounts for 0.5%-5% of the total molecular number of the polyester, that is, the number percentage content of polyester molecules with a molecular weight less than 5000 Da in polyester is 0.5%-5%; if the molecular number content of the polyester with a molecular weight of less than 5000 Da is too low, the film-forming property of the polyester will be poor and the yield rate will decrease; if the molecular number content of the polyester with a molecular weight of less than 5000 Da is too high, the mechanical property of the prepared polymer film will be poor; if the polydispersity index of the polyester is too small, the film-forming property of the polyester will be poor and the yield rate will decrease; and if the polydispersity index of polyester is too large, the mechanical property of the prepared polymer film will be poor. Therefore, by controlling the number average molecular mass of the raw material, the proportion of polyester molecules with a certain molecular weight to the total number of polyester molecules and the polydispersity index, the mechanical strength of the polymer film in the MD direction can be improved and the film breakage rate can be reduced. It should be noted that the “MD direction of the polymer film” in the present application refers to the mechanical direction, length direction or longitudinal direction of the polymer film.

Understandably, as per the mass percentage, the polymer film may include, for example, 95% of the polyester and 5% of the auxiliary agent, or may include 96% of the polyester and 4% of the auxiliary agent, or may include 97% of the polyester and 3% of the auxiliary agent, or may include 98% of the polyester and 2% of the auxiliary agent, or may include 99% of the polyester and 1% of the auxiliary agent; the number average molecular mass of the polyester may be, for example, 13000 Da, 13500 Da, 14000 Da, 14500 Da, 15000 Da, 15500 Da, 16000 Da, 16500 Da, 17000 Da, 17500 Da, 18000 Da, 18500 Da, 19000 Da, 19500 Da or 20000 Da; the molecular number of the polyester with a molecular weight less than 5000 Da may account for, for example, 0.5%, 1%, 1.5%, 2.0%, 2.5%, 3%, 3.5%, 4%, 4.5% or 5% of the total molecular number of the polyester; and the polydispersity index of the polyester may be, for example, 1.6, 1.7, 1.8, 1.9, 2.0, 2.1, 2.2, 2.3 or 2.4, and the polydispersity index of the polyester may be other values within 1.6-2.4.

In some of the Examples, the preparation method of the polymer film includes the following steps: performing a first longitudinal stretch treatment, a transverse stretch treatment, and a second longitudinal stretch treatment sequentially.

In some of the Examples, the process conditions of the first longitudinal stretch include: a first longitudinal stretch ratio of (3.0-4.0):1 and a first longitudinal stretch temperature of 80-120° C.

In some of the Examples, the process conditions of the transverse stretch include: a transverse stretch ratio of (3.0-4.0):1 and a transverse stretch temperature of 90-140° C.

In some of the Examples, the process conditions of the second longitudinal stretch include: a second longitudinal stretch ratio of (1.1-1.3):1 and a second longitudinal stretch temperature of 80-120° C.

Understandably, the first longitudinal stretch ratio may include but is not limited to 3.0:1, 3.1:1, 3.2:1, 3.3:1, 3.4:1, 3.5:1, 3.6:1, 3.7:1, 3.8:1, 3.9:1 or 4.0:1; the temperature of the first longitudinal stretch may include but is not limited to 80° C., 82° C., 85° C., 87° C., 89° C., 90° C., 92° C., 95° C., 98° C., 99° C., 100° C., 102° C., 105° C., 110° C., 115° C. or 120° C.; the transverse stretch ratio may include 3.0:1, 3.1:1, 3.2:1, 3.3:1, 3.4:1, 3.5:1, 3.6:1, 3.7:1, 3.8:1, 3.9:1 or 4.0:1; the temperature of the transverse stretch may include 90° C., 92° C., 94° C., 96° C., 98° C., 100° C., 102° C., 105° C., 110° C., 112° C., 115° C., 118° C., 120° C., 122° C., 125° C., 128° C., 130° C., 132° C., 135° C., 138° C. or 140° C. The second longitudinal stretch ratio may include but is not limited to 1.1:1, 1.12:1, 1.14:1, 1.16:1, 1.18:1, 1.2:1, 1.22:1, 1.24:1, 1.26:1, 1.28:1 or 1.3:1; the temperature of the second longitudinal stretch may include but is not limited to 80° C., 82° C., 85° C., 87° C., 89° C., 90° C., 92° C., 95° C., 98° C., 99° C., 100° C., 102° C., 105° C., 110° C., 115° C. or 120° C.

In some of the Examples, the polyester includes one or more of polyethylene terephthalate (PET), poly(ethylene 2,6-naphthalate) (PEN), polybutylene terephthalate (PBT), poly(1,4-cyclohexylenedimethylene terephthalate) (PCT), poly(ethylene glycol-co-1,4-cyclohexanedimethanol terephthalate) (PETG), poly(trimethylene 2,6-naphthalate) (PTN), polytrimethylene terephthalate (PTT), poly(butylene 2,6-naphthalate) (PBN), poly(butylene 2,5-furandicarboxylate), poly(butylene adipate-co-terephthalate) (PBAT), and their derivatives.

Understandably, the polyester may be, for example, any one of polyethylene terephthalate (PET), poly(ethylene 2,6-naphthalate) (PEN), polybutylene terephthalate (PBT), poly(1,4-cyclohexylenedimethylene terephthalate) (PCT), poly(ethylene glycol-co-1,4-cyclohexanedimethanol terephthalate) (PETG), poly(trimethylene 2,6-naphthalate) (PTN), polytrimethylene terephthalate (PTT), poly(butylene 2,6-naphthalate) (PBN), poly(butylene 2,5-furandicarboxylate), poly(butylene adipate-co-terephthalate) (PBAT), and their derivatives, or may be a mixture of more than one of the above materials in any proportion.

In some of the Examples, the auxiliary agent includes one or more of a slip agent, an antioxidant, an antistatic agent and a nucleating agent.

Understandably, the auxiliary agent may include, for example, any one of a slip agent, an antioxidant, an antistatic agent and a nucleating agent, or a mixture of more than one of a slip agent, an antioxidant, an antistatic agent and a nucleating agent in any proportion.

In some of the Examples, the slip agent includes one or more of titanium dioxide, silica, calcium carbonate, talcum powder, kaolin, diatomaceous earth, siloxane, and acrylic ester.

Understandably, the slip agent may be any one of titanium dioxide, silica, calcium carbonate, talcum powder, kaolin, diatomaceous earth, siloxane, and acrylic ester, or the slip agent may be a mixture of more than one of titanium dioxide, silica, calcium carbonate, talcum powder, kaolin, diatomaceous earth, siloxane, and acrylic ester in any proportion.

In some of the Examples, the antioxidant includes one or more of phosphonate and bisphenol A phosphite.

Understandably, the antioxidant may include, for example, phosphonate or bisphenol A phosphite, or may include both phosphonate and bisphenol A phosphite; the phosphonate may be, for example, antioxidant 1222 or antioxidant 300.

In some of the Examples, the antistatic agent includes one or more of glycerol, polyglycerol, polyethylene glycol, polyether ester, carbon black, graphite and conductive fibers.

Understandably, the antistatic agent may be any one of glycerol, polyglycerol, polyethylene glycol, polyether ester, carbon black, graphite and conductive fibers, or the antistatic agent may be a mixture of more than one of glycerol, polyglycerol, polyethylene glycol, polyether ester, carbon black, graphite and conductive fibers in any proportion.

In some of the Examples, the nucleating agent includes one or more of zinc oxide, aluminum oxide, magnesium oxide, copper oxide, barium sulfate, sodium carbonate, triphenyl phosphate, benzophenone, polycaprolactone, magnesium stearate and sodium benzoate.

Understandably, the nucleating agent may include any one of zinc oxide, aluminum oxide, magnesium oxide, copper oxide, barium sulfate, sodium carbonate, triphenyl phosphate, benzophenone, polycaprolactone, magnesium stearate and sodium benzoate, or may include a mixture of more than one of the above materials mixed in any proportion.

In some of the Examples, the shape of the auxiliary agent includes granular form, the average particle size of the granular auxiliary agent is 0.01-1.0 μm, and the average particle size D of the granular auxiliary agent and the thickness T of the polymer film satisfy the following condition: T≥0.3D.

Furthermore, the average particle size of the granular auxiliary agent is 0.02-0.5 μm.

Understandably, the auxiliary agent includes the granular auxiliary agent, and the granular auxiliary agent can improve the mechanical property of polymer film in the MD direction. The average particle size of the granular auxiliary agent may be, for example, 0.01 μm, 0.02 μm, 0.03 μm, 0.04 μm, 0.05 μm, 0.06 μm, 0.07 μm, 0.08 μm, 0.09 μm, 0.1 μm, 0.15 μm, 0.2 μm, 0.25 μm, 0.3 μm, 0.35 μm, 0.4 μm, 0.45 μm, 0.5 μm, 0.6 μm, 0.7 μm, 0.8 μm, 0.9 m or 1.0 m; the average particle size D of the granular auxiliary agent and the thickness T of the polymer film may satisfy the following conditions: for example, T=0.3D, T=0.32D, T=0.34D, T=0.35D, T=0.37D, T=0.39D, T=0.4D, T=0.42D, T=0.44D, T=0.46D, T=0.48D or T=0.5Q; when the average particle size of the granular auxiliary agent is too small, the efficiency of the auxiliary agent is not obvious; when the average particle size of the granular auxiliary agent is too large, defects easily form during the film preparation process; T≥3D is set to prevent film defects caused by the mismatch between the thickness of the polymer film and the granular auxiliary agent.

Another embodiment of the present application provides a preparation method for the high mechanical strength polymer film as described above, which includes the following steps:
preparing polyester sheets with 95%-99% of the polyester and 1%-5% of the auxiliary agent;
subjecting the polyester sheets to a crystallization treatment, a drying treatment, a melt-extrusion treatment, a sheet-casting treatment, a first longitudinal stretch treatment, a transverse stretch treatment, and a second longitudinal stretch treatment sequentially to prepare the polymer film.

Understandably, as per the mass percentage, the polymer film may include, for example, 95% of the polyester and 5% of the auxiliary agent, or may include 95.5% of the polyester and 4.5% of the auxiliary agent, or may include 96.5% of the polyester and 3.5% of the auxiliary agent, or may include 97.5% of the polyester and 2.5% of the auxiliary agent, or may include 98.5% of the polyester and 1.5% of the auxiliary agent, or may include 99% of the polyester and 1% of the auxiliary agent; the above first longitudinal stretch treatment, the transverse stretch treatment, and the second longitudinal stretch treatment can improve the mechanical property of the polymer film.

In some of the Examples, the process conditions of the crystallization treatment include: performing crystallization at a temperature of 135-185° C. for a period of 20-120 min.

Understandably, the temperature for crystallization may be any value within 135-185° C., for example, 135° C., 137° C., 140° C., 142° C., 145° C., 150° C., 153° C., 155° C., 160° C., 165° C., 175° C. or 185° C.; the period for crystallization may be 20 min, 25 min, 30 min, 35 min, 38 min, 40 min, 42 min, 45 min, 49 min, 53 min, 57 min, 60 min, 65 min, 70 min, 72 min, 77 min, 80 min, 82 min, 86 min, 90 min, 100 min, 105 min, 110 min, 111 min, 113 min, 117 min, or 120 min.

In some of the Examples, the process conditions of the drying treatment include: performing drying at a temperature of 135-175° C. for a period of 120-300 min.

Understandably, the temperature for drying may be any value within 135-175° C., for example, 135° C., 137° C., 140° C., 142° C., 145° C., 150° C., 153° C., 155° C., 160° C., 164° C., 166° C., 168° C., 170° C., 172° C., 174° C. or 175° C.; the period for drying may be 120 min, 125 min, 130 min, 135 min, 138 min, 140 min, 142 min, 145 min, 149 min, 153 min, 160 min, 170 min, 175 min, 180 min, 190 min, 200 min, 220 min, 240 min, 280 min, 285 min, 292 min, 295 min, or 300 min.

In some of the Examples, the melt extrusion is performed at a temperature of 270-290° C.

Understandably, the temperature for melt extrusion may be 270° C., 272° C., 274° C., 275° C., 277° C., 280° C., 282° C., 285° C., 286° C. or 290° C., and the temperature for melt extrusion may also be other values between 270-290° C.

In some of the Examples, the sheet-casting treatment includes the following steps: subjecting a material from the melt-extrusion treatment to casting treatment, and then cooling treatment.

Another embodiment of the present application provides a composite film, which includes a supporting film and a metal-enrichment layer, and at least one surface of the supporting film is attached with the metal-enrichment layer, and the supporting film includes the polymer film as described above or a polymer film prepared by the preparation method as described above.

In some of the Examples, a material of the metal-enrichment layer includes one or more of titanium, silver, copper, aluminum, nickel, a copper alloy, an aluminum alloy, and a nickel alloy.

It should be noted that, understandably, the metal-enrichment layer can be located on one surface of the polymer film or on both surfaces of the supporting film, and the material of the metal-enrichment layer can be consistent; the material of the metal-enrichment layer may be, for example, any one of titanium, silver, copper, aluminum, nickel, a copper alloy, an aluminum alloy and a nickel alloy, or the metal-enrichment layer may be formed by, for example, more than one of titanium, silver, copper, aluminum, nickel, a copper alloy, an aluminum alloy, and a nickel alloy.

In some of the Examples, the metal-enrichment layer has a thickness of 500-2000 nm.

It should be noted that the metal-enrichment layer can be made by one or more of the physical vapor deposition method, electroplating method and chemical plating method; the thickness of the metal-enrichment layer may be, for example, 500 nm, 510 nm, 515 nm, 520 nm, 525 nm, 530 nm, 535 nm, 540 nm, 545 nm, 550 nm, 560 nm, 570 nm, 580 nm, 590 nm, 600 μm, 610 μm, 630 μm, 650 μm, 670 μm, 700 μm, 770 μm, 860 μm, 950 μm, 1020 μm, 1110 μm, 1200 m, 1250 μm, 1340 μm, 1410 μm, 1540 μm, 1670 μm, 1750 μm, 1870 μm, 1920 m or 2000 μm.

In some of the Examples, the supporting film has a thickness of 1-20 μm.

It should be noted that considering the application requirements of composite current collectors in batteries as well as the difficulty and cost of the preparation process, the thickness of the supporting film is 1-20 m; the thickness of the supporting film may be but not limited to 1 μm, 1.5 μm, 2 μm, 2.5 μm, 3 μm, 3.5 μm, 4 μm, 4.2 μm, 5 μm, 5.7 μm, 6 μm, 6.8 μm, 7 μm, 8 μm, 8.5 μm, 9 μm, 9.2 μm, 9.8 μm, 10 μm, 11 μm, 11.4 μm, 12 μm, 12.7 μm, 13 μm, 14 μm, 15 μm, 18 μm or 20 μm.

Another embodiment of the present application provides a composite current collector, which includes the composite film as described above.

In some of the Examples, a surface of the metal-enrichment layer is attached with a protective layer.

It should be noted that the protective layer attached to the surface of the above composite current collector is used to prevent physical damage or chemical corrosion on the surface of the metal-enrichment layer.

In some of the Examples, the protective layer has a thickness of 10-150 nm.

Understandably, the thickness of the protective layer may be but not limited to 10 nm, 12 nm, 15 nm, 18 nm, 20 nm, 25 nm, 30 nm, 32 nm, 43 nm, 45 nm, 52 nm, 56 nm, 63 nm, 77 nm, 89 nm, 92 nm, 95 nm, 98 nm, 100 nm, 105 nm, 110 nm, 115 nm, 118 nm, 120 nm, 125 nm, 128 nm, 130 nm, 135 nm, 137 nm, 140 nm, 143 nm, 146 nm, or 150 nm.

In some of the Examples, a material of the protective layer includes one or more of graphite, nickel, chromium, carbon black, copper oxide, acetylene black, aluminum oxide, nickel oxide, Ketjen black, chromium oxide, cobalt oxide, a nickel-based alloy, a copper-based alloy, carbon nano-quantum dots, carbon nanotubes, carbon nanofibers, and graphene.

Another embodiment of the present application provides an electrode sheet, which includes the composite current collector and an active substance layer attached to at least one surface of the composite current collector.

It should be noted that the active substance layer includes an active substance, a conductive agent and a binder, and the active substance is divided into a positive active substance and a negative active substance, wherein the positive active material may be lithium cobalt oxide, lithium manganese oxide, lithium iron phosphate or ternary positive material, etc.; the negative active material may be graphite, silicon material, silicon-carbon composite material, etc.; the conductive agent may be conductive carbon black, carbon fiber, graphene, and carbon nanotubes, etc.; and the binder may be PVDF, CMC, and SBR, etc. There are no special restrictions on the active substance, the conductive agent and the binder in the present application, and the active substances, conductive agents and binders commonly used in the field of batteries are all within the scope of the active substance layer of the present application.

Another embodiment of the present application provides a lithium secondary battery, which includes the above electrode sheet.

Understandably, the electrode sheets can be divided into positive electrode sheets and negative electrode sheets according to the different active substances in the active substance layer. In the battery of the present application, the above electrode sheet may be used as the positive electrode sheet, or the above electrode sheet may be used as the negative electrode sheet, or the above electrode sheet may be used as both the positive electrode sheet and the negative electrode sheet. There are no special restrictions on lithium secondary batteries in the present application, and the preparation methods commonly used in the field of lithium secondary batteries are all within the scope of batteries of the present application, for example, the positive electrode sheet, the negative electrode sheet, the non-aqueous electrolyte and the necessary components of the general battery can be assembled with the battery shell by laminating or winding to form a lithium secondary battery.

Another embodiment of the present application provides an electronic device, which includes the above battery.

Understandably, the above battery can be used as a drive power supply or a power storage device for machinery, equipment, instruments, devices, or combined systems thereof; application examples of the above-mentioned batteries include, for example, mobile phones, laptops, smart home appliances, and electric vehicles.

The parameter determination of the present application may optionally be performed by the following methods.

(1) Tests on mechanical properties of polymer films and composite current collectors were carried out with reference to the national standard GB/T 1040.3-2006.

(2) Tests on the defect rates of the polymer films and composite current collectors were carried out; the defect rate is the proportion of the number of unqualified products caused by breakage during the preparation process to the total number of products, and the number of products was calculated by length in view of the consistent width.

The present application are further described below in terms of specific embodiments.

### Example 1

The preparation method of the polymer film was as follows:
step 1: polyester sheets were made of polyethylene terephthalate (PET), antioxidant 1222, titanium dioxide, silica and aluminum oxide by heating-melting-mixing, extrusion and sheet-forming; as per the mass percentage, the contents of PET, antioxidant 1222, titanium dioxide, silica and aluminum oxide were 98%, 0.5%, 0.5%, 0.5% and 0.5%, respectively; the number average molecular mass of PET was 13000 Da, the polydispersity index was 1.6, and the number percentage content of PET molecules with a molecular weight less than 5000 Da in PET was 0.5%; and in the auxiliary agent, the sizes of the of antioxidant 1222, titanium dioxide, silica and aluminum oxide were all 50-100 nm;
step 2: The PET sheets prepared in step 1 were transported to a crystallizer, crystallized at 145° C. for 40 min, and then transported to a drying tower and dried at 155° C. for 160 min;
step 3: the polyester sheets prepared in step 2 were fed into a twin-screw extruder, and heated to 280° C. to melt, and the molten material was extruded through a die with the help of a metering pump;
step 4: the molten material extruded in step 3 was cast onto a casting roller, and shaped to form a polyester sheet with a thickness of 59.4 m by a casting roller and water-cooling treatment;
step 5: the polyester sheet prepared in step 4 was preheated at 90° C., and subjected to the first longitudinal stretch at 110° C. with a stretch ratio of 3.0:1, heat setting at 170° C., and then cooling molding at 40° C.;
step 6: the polyester sheet obtained in step 5 was preheated at 90° C., and subjected to the transverse stretch at 120° C. with a stretch ratio of 3.0:1, heat setting at 170° C., and then cooling molding at 90° C. in the medium cooling zone and at 35° C. in the cooling zone in sequence;
step 7: the polyester sheet obtained in step 6 was preheated at 90° C., and subjected to the second longitudinal stretch at 110° C. with a stretch ratio of 1.1:1, heat setting at 170° C., and then cooling molding at 40° C. to obtain the polymer film with a thickness of 6 m; and
step 8: the polymer film obtained in step 7 was introduced into a winding system by a traction system for winding.

### Example 2

This example is basically the same as Example 1, except that the number average molecular mass of PET was 16000 Da.

### Example 3

This example is basically the same as Example 1, except that the number average molecular mass of PET was 19000 Da.

### Example 4

This example is basically the same as Example 1, except that the number average molecular mass of PET was 20000 Da.

### Example 5

This example is basically the same as Example 3, except that the polydispersity index of PET was 1.9.

### Example 6

This example is basically the same as Example 3, except that the polydispersity index of PET was 2.2.

### Example 7

This example is basically the same as Example 3, except that the polydispersity index of PET was 2.4.

### Example 8

This example is basically the same as Example 6, except that the number percentage content of PET molecules with a molecular weight less than 5000 Da in PET was 3%.

### Example 9

This example is basically the same as Example 6, except that the number percentage content of PET molecules with a molecular weight less than 5000 Da in PET was 5%.

### Example 10

This example is basically the same as Example 8, except that the stretch ratio of the first longitudinal stretch was 2.5:1.

### Example 11

This example is basically the same as Example 8, except that the stretch ratio of the first longitudinal stretch was 3.5:1.

### Example 12

This example is basically the same as Example 8, except that the stretch ratio of the first longitudinal stretch was 4.0:1.

### Example 13

This example is basically the same as Example 8, except that the stretch ratio of the first longitudinal stretch was 4.5:1.

### Example 14

This example is basically the same as Example 12, except that the second longitudinal stretch treatment was not performed.

### Example 15

This example is basically the same as Example 12, except that the stretch ratio of the second longitudinal stretch was 1.2:1.

### Example 16

This example is basically the same as Example 12, except that the stretch ratio of the second longitudinal stretch was 1.3:1.

### Example 17

This example is basically the same as Example 12, except that the stretch ratio of the second longitudinal stretch was 1.4:1.

### Example 18

This example is basically the same as Example 1, except that as per the mass percentage, contents of PET, antioxidant 1222, titanium dioxide, silica and aluminum oxide were 95%, 1.5%, 0.5%, 1.5% and 1.5%, respectively.

### Example 19

This example is basically the same as Example 1, except that as per the mass percentage, contents of PET, antioxidant 1222, titanium dioxide, silica and aluminum oxide were 99%, 0.25%, 0.25%, 0.25% and 0.25%, respectively.

### Example 20

This example is basically the same as Example 1, except that in step 1, polyester sheets were made of poly(ethylene 2,6-naphthalate) (PEN), antioxidant 1222, titanium dioxide, silica and aluminum oxide by heating-melting-mixing, extrusion and sheet-forming.

### Example 21

This example is basically the same as Example 1, except that in step 1, polyester sheets were made of poly(ethylene glycol-co-1,4-cyclohexanedimethanol terephthalate) (PETG), antioxidant 1222, titanium dioxide, silica and aluminum oxide by heating-melting-mixing, extrusion and sheet-forming.

### Example 22

This example is basically the same as Example 1, except that in step 1, polyester sheets were made of polybutylene terephthalate (PBT), antioxidant 1222, titanium dioxide, silica and aluminum oxide by heating-melting-mixing, extrusion and sheet-forming.

### Example 23

This example is basically the same as Example 1, except that in step 1, polyester sheets were made of poly(butylene 2,6-naphthalate) (PBN), antioxidant 1222, titanium dioxide, silica and aluminum oxide by heating-melting-mixing, extrusion and sheet-forming.

### Example 24

This example is basically the same as Example 1, except that in step 1, polyester sheets were made of poly(butylene adipate-co-terephthalate) (PBAT), antioxidant 1222, titanium dioxide, silica and aluminum oxide by heating-melting-mixing, extrusion and sheet-forming.

### Comparative Example 1

This comparative example is basically the same as Example 1, except that the number average molecular mass of PET was 12000 Da.

### Comparative Example 2

This comparative example is basically the same as Example 1, except that the number average molecular mass of PET was 21000 Da.

### Comparative Example 3

This comparative example is basically the same as Example 3, except that the polydispersity index of PET was 1.5.

### Comparative Example 4

This comparative example is basically the same as Example 3, except that the polydispersity index of PET was 2.5.

### Comparative Example 5

This comparative example is basically the same as Example 6, except that the number percentage content of PET molecules with a molecular weight less than 5000 Da in PET was 0.4%.

### Comparative Example 6

This comparative example is basically the same as Example 6, except that the number percentage content of PET molecules with a molecular weight less than 5000 Da in PET was 5.1%.

### Comparative Example 7

This comparative example is basically the same as Example 1, except that as per the mass percentage, contents of PET, antioxidant 1222, titanium dioxide, silica and aluminum oxide were 94%, 1.5%, 1.5%, 1.5% and 1.5%, respectively.

### Comparative Example 8

This comparative example is basically the same as Example 1, except that as per the mass percentage, contents of PET, antioxidant 1222, titanium dioxide, silica and aluminum oxide were 100%, 0%, 0%, 0% and 0%, respectively.

### Preparation of Composite Current Collector

Aluminum wire with a purity greater than 99.99% was melted and evaporated at 1400° C. and deposited on two surfaces of the polymer films prepared in the above Examples 1-24 and Comparative Examples 1-8 to form aluminum metal-enrichment layers of 1 m thickness; carbon nanotubes and N-methylpyrrolidone were prepared into a solution with a solid content of 0.1 wt %, and the above solution was evenly coated to the surface of the aluminum metal-enrichment layer with a coating amount of 90 μm, and dried at 100° C. to obtain the composite current collector.

The performance data of the polymer films prepared in Examples 1-24 and Comparative Examples 1-8 and composite current collectors are shown in Table 1 and Table 2.

TABLE 1

| | Polymer film | | | |
|---|---|---|---|---|
| | | Elastic | Tensile | Elongation |
| | | modulus in | strength in | at break |
| | Defect | MD direction | MD direction | in MD |
| Group | rate (%) | (MPa) | (MPa) | direction (%) |
| Example 1 | 0 | 5305 | 275 | 115 |
| Example 2 | 0 | 5411 | 298 | 108 |
| Example 3 | 0 | 5500 | 309 | 103 |
| Example 4 | 0 | 5567 | 307 | 98 |
| Example 5 | 0 | 5538 | 318 | 99 |
| Example 6 | 0 | 5576 | 326 | 97 |
| Example 7 | 0 | 5521 | 311 | 101 |
| Example 8 | 0 | 5591 | 341 | 93 |
| Example 9 | 0 | 5569 | 322 | 98 |
| Example 10 | 0 | 5356 | 288 | 111 |
| Example 11 | 0 | 5630 | 356 | 90 |
| Example 12 | 0 | 5675 | 371 | 87 |
| Example 13 | 10 | 5702 | 378 | 85 |
| Example 14 | 0 | 5565 | 318 | 96 |
| Example 15 | 0 | 5691 | 386 | 83 |
| Example 16 | 0 | 5733 | 395 | 81 |
| Example 17 | 15 | 5799 | 403 | 70 |
| Example 18 | 0 | 5221 | 257 | 124 |
| Example 19 | 0 | 5265 | 265 | 120 |
| Example 20 | 0 | 5397 | 290 | 109 |
| Example 21 | 0 | 5210 | 251 | 127 |
| Example 22 | 0 | 5280 | 269 | 120 |
| Example 23 | 0 | 5349 | 282 | 112 |
| Example 24 | 0 | 5369 | 286 | 110 |
| Comparative | 0 | 5150 | 245 | 127 |
| Example 1 | | | | |
| Comparative | 8 | 5667 | 299 | 95 |
| Example 2 | | | | |
| Comparative | 6 | 5479 | 301 | 90 |
| Example 3 | | | | |
| Comparative | 0 | 5392 | 291 | 99 |
| Example 4 | | | | |
| Comparative | 3 | 5378 | 278 | 101 |
| Example 5 | | | | |
| Comparative | 0 | 5201 | 255 | 121 |
| Example 6 | | | | |
| Comparative | 3 | 4990 | 233 | 131 |
| Example 7 | | | | |
| Comparative | 2 | 5098 | 240 | 129 |
| Example 8 | | | | |

TABLE 2

| | Composite current collector | | | |
|---|---|---|---|---|
| | | Elastic | Tensile | Elongation |
| | | modulus in | strength in | at break |
| | Defect | MD direction | MD direction | in MD |
| Group | rate (%) | (MPa) | (MPa) | direction (%) |
| Example 1 | 3 | 13000 | 160 | 20.1 |
| Example 2 | 0 | 13989 | 176 | 18.3 |
| Example 3 | 0 | 14398 | 193 | 17.5 |
| Example 4 | 0 | 14576 | 190 | 17.1 |
| Example 5 | 0 | 14960 | 205 | 16.8 |
| Example 6 | 0 | 15388 | 214 | 16.4 |
| Example 7 | 0 | 14432 | 190 | 17.7 |
| Example 8 | 0 | 15873 | 229 | 16.0 |
| Example 9 | 0 | 15021 | 209 | 16.6 |
| Example 10 | 2 | 13450 | 178 | 18.6 |
| Example 11 | 0 | 16105 | 243 | 15.7 |
| Example 12 | 0 | 16500 | 259 | 15.3 |
| Example 13 | 0 | 16567 | 262 | 15.2 |
| Example 14 | 0 | 14769 | 203 | 16.9 |
| Example 15 | 0 | 16831 | 275 | 15.1 |
| Example 16 | 0 | 17122 | 283 | 15.0 |
| Example 17 | 0 | 17989 | 292 | 14.3 |
| Example 18 | 4 | 12511 | 149 | 20.8 |
| Example 19 | 3 | 12780 | 156 | 20.5 |
| Example 20 | 1 | 13788 | 173 | 18.5 |
| Example 21 | 4 | 12499 | 145 | 30.0 |
| Example 22 | 3 | 12891 | 158 | 20.4 |
| Example 23 | 2 | 13390 | 166 | 19.2 |
| Example 24 | 1 | 13402 | 169 | 19.0 |
| Comparative | 10 | 12001 | 143 | 20.7 |
| Example 1 | | | | |
| Comparative | 0 | 14721 | 187 | 17.3 |
| Example 2 | | | | |
| Comparative | 0 | 15221 | 189 | 16.2 |
| Example 3 | | | | |
| Comparative | 1 | 14192 | 180 | 18.2 |
| Example 4 | | | | |
| Comparative | 2 | 13856 | 171 | 17.4 |
| Example 5 | | | | |
| Comparative | 8 | 12531 | 146 | 20.5 |
| Example 6 | | | | |
| Comparative | 13 | 11890 | 132 | 21.1 |
| Example 7 | | | | |
| Comparative | 11 | 11961 | 135 | 20.9 |
| Example 8 | | | | |

### Example 2

It can be seen from the analysis of Tables 1 and 2:
the difference between Example 1 and Comparative Examples 1 and 2 is that the number average molecular mass of PET is different, and compared with Comparative Examples 1 and 2, the polymer film prepared in Example 1 can ensure a lower defect rate, and also a high elastic modulus in the MD direction, high tensile strength in the MD direction and high elongation at break in the MD direction, and the elastic modulus of the polymer film prepared in Example 1 can reach 5305 MPa; compared with Comparative Example 1, the composite current collector prepared in Example 1 can ensure a decreased defect rate, and also an improved elastic modulus in the MD direction and tensile strength in the MD direction, and the elongation at break in the MD direction of the composite current collector prepared in Example 1 is not much different from that in Comparative Example 1; compared with Example 1, the defect rate of the composite current collector prepared in Comparative Example 2 is reduced, the elastic modulus in the MD direction and the tensile strength in the MD direction are increased, but the elongation at break in Comparative Example 2 is significantly reduced, which indicates that compared with Comparative Examples 1 and 2, the polymer film and composite current collector prepared in Example 1 can take into account both the defect rate and the elongation at break in the MD direction, and improve the elastic modulus in the MD direction and the tensile strength in the MD direction simultaneously;
the difference between Example 3 and Comparative Examples 3 and 4 is that the polydispersity index of PET is different, and compared with Comparative Examples 3 and 4, the polymer film prepared in Example 3 has an effectively improved elastic modulus in MD direction, tensile strength in MD direction and elongation at break in MD direction, and also a low defect rate simultaneously, and the elastic modulus of the polymer film prepared in Example 3 in MD direction can reach 5500 MPa, the tensile strength in MD direction can reach 309 MPa, and the elongation at break in MD direction can reach 103%; compared with the composite current collectors prepared in Comparative Examples 3 and 4, the composite current collector prepared in Example 3 can ensure high elastic modulus and high tensile strength in the MD direction with considering elongation at break and defect rate in the MD direction, therefore, the mechanical properties of the polymer film and the composite current collector prepared in Example 3 are better;
the difference between Example 6 and Comparative Examples 5 and 6 is that the number percentage content of the PET molecules with a molecular weight less than 5000 Da in PET is different, and compared with Comparative Examples 5 and 6, the polymer film prepared in Example 6 is significantly improved in the elastic modulus in the MD direction and the tensile strength in the MD direction under the condition of a low defect rate, and the elongation at break in the MD direction is not much different from that in Comparative Example 5; compared with the composite current collectors prepared in Comparative Examples 5 and 6, the composite current collector prepared in Example 6 has significantly improved elastic modulus in the MD direction and tensile strength in the MD direction and decreased defect rate under the condition that the elongation at break in the MD direction is not much different from that in Example 5, which indicates that compared with Comparative Examples 5 and 6, a better mechanical property is shown in Example 6;

Compared with Comparative Examples 7 and 8, the polymer film prepared in Example 1 can reduce the defect rate, and greatly improve the elastic modulus in the MD direction and the tensile strength in the MD direction simultaneously, and the elongation at break in the MD direction is not much different from that of Comparative Example 8; compared with Comparative Examples 7 and 8, the composite current collector prepared in Example 1 has not only greatly improved elastic modulus in the MD direction and tensile strength in the MD direction in the MD direction, and decreased defect rate, but also similar elongation at break in the MD direction to that of Comparative Examples 7 and 8, which indicates that the auxiliary agent in the polymer film of the present application can improve the mechanical properties in the MD direction of the polymer film and the composite current collector.

The technical features of the above embodiments may be optionally combined, and for the sake of conciseness, possible combinations of the technical features in the above embodiments are not described exhaustively, however, as long as there is no contradiction between the combinations of these technical features, they shall be deemed to be within the scope of the present application.

The above examples only describe several embodiments of the present application, and the descriptions are specific and detailed, but they cannot be understood as restricting the scope of the present application. It should be noted that, for those skilled in the art, a number of variations and improvements can be made without departing from the conception of the present application, which shall fall within the protection scope of the present application. Therefore, the protection scope of the present application should be subject to the claims.

1. A polymer film, which comprises a polyester with a mass percentage of 95%-99% and an auxiliary agent of 1%-5%, wherein a number average molecular mass of the polyester is 13000-20000 Da, and a molecular number of the polyester with a molecular weight of less than 5000 Da accounts for 0.5%-5% of the total molecular number of the polyester, and a polydispersity index of the polyester is 1.6-2.4.

2. The polymer film according to claim 1, wherein a preparation method of the polymer film comprises the following steps: performing a first longitudinal stretch treatment, a transverse stretch treatment, and a second longitudinal stretch treatment sequentially.

3. The polymer film according to claim 1, wherein the polyester comprises one or more of polyethylene terephthalate, poly(ethylene 2,6-naphthalatc), polybutylene terephthalate, poly(1,4-cyclohexylenedimethylene terephthalate), poly(ethylene glycol-co-1,4-cyclohexanedimethanol terephthalate), poly(trimethylene 2,6-naphthalate), polytrimethylene terephthalate, poly(butylene 2,6-naphthalate), poly(butylene 2,5-furandicarboxylate), poly(butylene adipate-co-terephthalate), and their derivatives.

4. The polymer film according to claim 1, wherein the auxiliary agent comprises one or more of a slip agent, an antioxidant, an antistatic agent and a nucleating agent;
optionally, the antistatic agent comprises one or more of conductive fibers, polyethylene glycol, glycerol, polyether ester, polyglycerol, graphite, and carbon black;
optionally, the nucleating agent comprises one or more of sodium carbonate, benzophenone, zinc oxide, copper oxide, magnesium stearate, triphenyl phosphate, aluminum oxide, magnesium oxide, barium sulfate, polycaprolactone, and sodium benzoate.

5. A preparation method of the polymer film according to claim 1, which comprises the following steps:
preparing polyester sheets with 95%-99% of the polyester and 1%-5% of the auxiliary agent;
subjecting the polyester sheets to a crystallization treatment, a drying treatment, a melt-extrusion treatment, a sheet-casting treatment, a first longitudinal stretch treatment, a transverse stretch treatment, and a second longitudinal stretch treatment sequentially to prepare the polymer film.

6. The preparation method according to claim 5, which comprises at least one of features (1)-(4):
(1) process conditions of the crystallization treatment comprise: performing crystallization at a temperature of 135-185° C. for a period of 20-120 min;
(2) process conditions of the drying treatment comprise: performing drying at a temperature of 135-175° C. for a period of 120-300 min;
(3) the melt-extrusion treatment is performed at a temperature of 270-290° C.; and
(4) the sheet-casting treatment comprises the following steps: subjecting a material from the melt-extrusion treatment to casting treatment, and then cooling treatment.

7. A composite film, which comprises a supporting film and a metal-enrichment layer, and at least one surface of the supporting film is attached with the metal-enrichment layer, and the supporting film comprises the polymer film according to claim 1.

8. The composite film according to claim 7, which comprises at least one of features (1)-(3):
(1) a material of the metal-enrichment layer comprises one or more of titanium, silver, copper, aluminum, nickel, n conner alloy, an aluminum alloy, and a nickel alloy;
(2) the metal-enrichment layer has a thickness of 500-2000 nm; and
(3) the supporting film has a thickness of 1-20 μm.

9. A composite current collector, which comprises the composite film according to claim 7.

10. The composite current collector according to claim 9, wherein a surface of the metal-enrichment layer is attached with a protective layer.

11. The composite current collector according to claim 10, wherein the protective layer has a thickness of 10-150 nm.

12. The composite current collector according to claim 10, wherein a material of the protective layer comprises one or more of graphite, nickel, chromium, carbon black, copper oxide, acetylene black, aluminum oxide, nickel oxide, Ketjen black, chromium oxide, cobalt oxide, a nickel-based alloy, a copper-based alloy, carbon nano-quantum dots, carbon nanotubes, carbon nanofibers, and graphene.

13. An electrode sheet, which comprises the composite current collector according to claim 9, and an active substance layer attached to at least one surface of the composite current collector.

14. A lithium secondary battery, which comprises the electrode sheet according to claim 13.

15. An electronic device, which comprises the battery according to claim 14.

16. The polymer film according to claim 2, wherein process conditions of the first longitudinal stretch treatment comprise: a first longitudinal stretch ratio of (3.0-4.0):1 and a first longitudinal stretch temperature of 80-120° C.

17. The polymer film according to claim 2, wherein process conditions of the transverse stretch treatment comprise: a transverse stretch ratio of (3.0-4.0):1 and a transverse stretch temperature of 90-140° C.

18. The polymer film according to claim 2, wherein process conditions of the second longitudinal stretch treatment comprise: a second longitudinal stretch ratio of (1.1-1.3):1 and a second longitudinal stretch temperature of 80-120° C.

19. The polymer film according to claim 4, wherein the slip agent comprises one or more of calcium carbonate, talcum powder, diatomaceous earth, acrylic ester, siloxane, titanium dioxide, kaolin and silica.

20. The polymer film according to claim 4, wherein the antioxidant comprises one or more of phosphonate and bisphenol A phosphite.
